(19) United States
(12) Patent Application Publication
(10) Pub. No.: US 2015/0275148 A1
(43) Pub. Date: Oct. 1, 2015

(54) LIQUID DETERGENT COMPOSITIONS

(71) Applicant: THE SUN PRODUCTS CORPORATION, Wilton, CT (US)

(72) Inventors: David Joiner, Wake Forest, NC (US); Calogero Distefano, Milford, CT (US)

(73) Assignee: THE SUN PRODUCTS CORPORATION, Wilton, CT (US)

(21) Appl. No.: 14/395,393

(22) PCT Filed: Apr. 19, 2013
(86) PCT No.: PCT/US2013/037435

§ 371 Date: Oct. 17, 2014

Related U.S. Application Data
(60) Provisional application No. 61/635,926, filed on Apr. 20, 2012.

(30) Foreign Application Priority Data
May 24, 2012 (EP) 12169337.8

(51) Int. Cl. C11D 3/386; C11D 1/83; C11D 17/00

(52) U.S. Cl. CPC C11D 3/38618; C11D 17/0008; C11D 1/83

(57) ABSTRACT

The present invention relates to a clear and/or colorless liquid detergent composition comprising enzyme, polyol, surfactants and water, wherein the amount of water is less than 15% of the total detergent composition volume. The invention further relates to methods of producing and uses of such compositions.

### BACKGROUND OF THE INVENTION

1. Field of the Invention

The present invention relates to the field of liquid detergent compositions in particular non aqueous detergent compositions. The invention further relates to methods for producing and use of such liquid detergents compositions.

2. Background Art

Enzyme containing detergents were introduced in the early part of the 1900s. However, the enzyme concept did not catch on until the sixties with the availability of thermally and alkali robust bacterial enzymes. For almost 20 years, bacterial proteases were the only class of enzymes of real commercial importance. Then the use of amylases, lipases, and cellulases as detergent ingredients started to take off during the 1980s and grew steadily in importance during the 1990s. One of the largest applications of detergents is for cleaning clothing. The formulations are complex, reflecting the diverse demands of the application. In general, laundry detergents contain, in addition to enzymes, many components such as builders, surfactants, bleaches and brighteners. Liquid detergent compositions are by some consumers considered to be more convenient to use than are dry powdered or particulate detergents. However, liquid detergents inherently possess some disadvantages. In particular, detergent composition components which may be compatible with each other in granular products may tend to interact or react with each other. One approach for enhancing the chemical compatibility of detergent composition components in detergents has been to formulate non-aqueous liquid detergent compositions. In addition, reducing the amount of non-reactive ingredients like water reduces the volume of detergent compositions, which results in a more compact detergent composition. A particular problem has been observed with the incorporation of enzymes in non-aqueous detergents. The addition of enzymes to non-aqueous detergent may cause turbidity (or haze) in addition to coloring of the detergent composition. It is important to ensure that the detergent formulation is physically stable, meaning that no phase separation occurs during product storage. Product physical stability is an important parameter that is typically thoroughly addressed when developing a new detergent product formulation. Thus it is an object of the present invention to provide an enzyme containing liquid detergent which is clear and/or colorless.

### BRIEF SUMMARY OF THE INVENTION

The invention provides a clear and/or colorless non-aqueous liquid detergent composition comprising

25 to 70 wt % nonionic surfactant
5 to 40 wt % polyol
0 to 15 wt % water, and
at least 0.1 wt % enzyme and an anionic surfactant; wherein the anionic surfactant is included in an amount of at least 0.1 g anionic surfactant per g total enzyme protein in the detergent composition.

The invention further relates to a method of producing a clear and colorless liquid detergent composition wherein said method comprises: adding at least one enzyme and at least one anionic surfactant to a non-aqueous liquid detergent base in an amount of at least 0.1 g anionic surfactant per g total enzyme protein in the detergent composition.

The invention also relates to the use of an anionic surfactant to solubilize an enzyme, wherein the anionic surfactant is added to a non-aqueous liquid detergent base in an amount corresponding to at least 0.1 g anionic surfactant per g total enzyme protein in the detergent composition

### BRIEF DESCRIPTION OF THE DRAWINGS/FIGURES

FIG. 1 shows turbidity of Detergent G with added sodium dodecyl sulfate and 2.5% Savinase.

FIG. 2 shows the resulting turbidity for anionic co-surfactants added at specified concentration in Detergent G with 2.5% Savinase (dashed line is without co-surfactant; below solid lines indicates clear solution).

FIG. 3 shows turbidity results for various commercial proteases with and without anionic co-surfactant in Detergent G.

### DETAILED DESCRIPTION OF THE INVENTION

The present invention relates to liquid compositions comprising enzymes. In particular the invention relates to liquid detergent compositions such as laundry and dish wash detergent compositions.

### Liquid Detergents

Detergent is defined as any substance or preparation containing soaps and/or other surfactants intended for washing and cleaning processes. Thus detergents are cleansing agents that differ from soap but can also emulsify oils and hold dirt in suspension. Detergents may be in any form (liquid, powder, paste, bar, cake, moulded piece, shape, etc.) and used e.g., in household, or institutional or industrial purposes. Detergents includes auxiliary washing preparation, intended for soaking (pre-washing), rinsing or bleaching clothes, household linen, etc.; laundry fabric-softener, intended to modify the feel of fabrics in processes which are to complement the washing of fabrics; “Cleaning preparation”, intended for domestic all purposes cleaners and/or other cleaning of surfaces (e.g., materials, products, machinery, mechanical appliances, means of transport and associated equipment, instruments, apparatus, etc.);

Laundry detergent, or washing powder, is a type of detergent (cleaning agent) that is added for cleaning laundry. In common usage, “detergent” refers to mixtures of chemical compounds including alkylbenzenesulfonates, which are similar to soap but are less affected by “hard water.”

Liquid detergent is a detergent in liquid form. A liquid is a form of matter with a definite volume but no fixed shape and a liquid formulation is a formulation in liquid form. A formulation or a preparation is a substance prepared according to a formula.

A unit dose detergent product is the packaging of a single dose in a non-reusable container. It is increasingly used in detergents for laundry and dish wash. A detergent unit dose product is the packaging of the amount of detergent used for a single wash. These unit doses could be, e.g., capsules or pouches and may be single or multi chambered.

Detergent compositions are generally formulated to contain a variety of active ingredients, typically one or more surfactant, detergent builder materials such as alkali metal carbonates and zeolites, electrolytes and adjuvants such as brighteners, perfumes and colorants, all of which in the case of a liquid composition must be dispersed or dissolved in an aqueous medium. The combination of these ingredients have limited solubility in water and one of the principal problems to be overcome in formulating a commercially desirable liquid detergent product are stability of the composition, particularly for liquid products containing high levels of surfactants and builders.

Compact detergents have, along with the environmental benefit of smaller packaging and a reduction in manufacturing waste, the benefit of use of less detergent per wash load and better cleaning power.

Liquid detergent products are generally more concentrated and compact relative to powder detergents and also allow for ease of operation with respect to targeting the removal of specific stains on fabrics, such as by a pre-spotting or pre-soak step prior to laundering the soiled fabrics in a home washing machine.

One way of achieving a more concentrated liquid detergent is to reduce the amount of non-active ingredients such as water. Thus a particular aspect of the invention concern a non-aqueous liquid detergent composition wherein the composition comprises less than 15% water of the total volume, preferably less than 14%, such as less than 13%, such as less than 12%, such as less than 11%, such as less than 10%, such as less than 9%, such as less than 8%, such as less than 7%, such as less than 6%, such as less than 5%, such as less than 4%, such as less than 3%, such as less than 2%, such as less than 1% or even 0% water of the total volume detergent composition. Thus a non-aqueous liquid detergent composition is defined as solution wherein the total water content in wt is below 15%.

The liquid detergent composition may also be formulated as a liquid enzyme additive, which is a product to be used as a raw material or premix in manufacturing of a finished product such as detergents.

### Enzymes in Liquid Detergents

The addition of enzymes to most liquid detergents may cause turbidity (or haze) and in some cases also add color to the detergent composition. This is particularly profound in non-aqueous (i.e., <15% water) liquid detergents. Thus prior art detergent compositions are often turbid suspensions which are susceptible to product separation over prolonged periods of storage. Consequently, the problems of enzyme stability and physical product stability remain as problems yet to be overcome in formulating enzyme containing liquid detergent compositions.

Thus, one aspect of the invention concerns a non-aqueous liquid detergent base comprising

25 to 70 wt % nonionic surfactant
5 to 40 wt % polyol and
0 to 15 wt % water

Thus, it is an object of the invention to provide stable clear and/or colorless liquid formulations, in particular detergent compositions comprising at least one enzyme. A clear solution such as a clear liquid detergent composition is a liquid detergent composition with turbidity less than approximately 25 NTU when measured as described in Example 1. It has been surprisingly found that the incorporation of relatively small amounts of an anionic co-surfactant can render the detergent clear and colorless.

Thus, one particular aspect of the invention concern

A clear and/or colorless non-aqueous liquid detergent composition comprising
25 to 70 wt % nonionic surfactant
5 to 40 wt % polyol
0 to 15 wt % water, and
at least 0.1 wt % enzyme and an anionic surfactant; wherein the anionic surfactant is included in an amount of at least 0.1 g anionic surfactant per g total enzyme protein in the detergent composition.

Enzymes useable in the above compositions comprise proteases, lipases, amylases, cellulases, mannanase, pectate lyase, mannosidases or enzymes of the classes; oxidoreductase, transferase, hydrolase, lyase, isomerase, and/or ligase as well as other enzymes or mixtures thereof.

The enzymes may be added in a concentration of about 0.1 wt % to 10 wt %, in a preferred aspect the total concentration of enzyme in the detergent is about 0.1 wt % enzyme, such as 0.2 wt %, such as 0.3 wt %, such as 0.4 wt %, such as 0.5 wt %, such as 0.6 wt %, such as 0.7 wt %, such as 0.8 wt %, such as 0.9 wt %, such as 1.0 wt %, such as 1.5 wt %, such as 2.0 wt %, such as 2.5 wt %, such as 3.0 wt %, such as 3.5 wt %, such as 4.0 wt %, such as 4.5 wt %, such as 5.0 wt %, such as 5.5 wt %, such as 6.0 wt %, such as 6.5 wt %, such as 7.0 wt %, such as 7.5 wt %, such as 8.0 wt %, such as 8.5 wt %, such as 9.0 wt %, such as 9.5 wt % or such as 10 wt %.

Thus, one aspect of the invention concerns a clear and/or colorless non-aqueous liquid detergent composition comprising

25 to 70 wt % nonionic surfactant
5 to 40 wt % polyol
0 to 15 wt % water, and
0.1 wt % to 5 wt % enzyme and an anionic surfactant; wherein the anionic surfactant is included in an amount of at least 0.1 g anionic surfactant per g total enzyme protein in the detergent composition.

The most important commercial enzymes are proteases. The most widely used proteases in detergents are the serine proteases. A serine protease is an enzyme which catalyzes the hydrolysis of peptide bonds, and in which there is an essential serine residue at the active site (White, Handler and Smith, 1973 “Principles of Biochemistry,” Fifth Edition, McGraw-Hill Book Company, NY, pp. 271-272). A sub-group of the serine proteases tentatively designated subtilases has been proposed by Siezen et al., Protein Engng. 4 (1991) 719-737 and Siezen et al. Protein Science 6 (1997) 501-523. One subgroup of the subtilases, I-S1 or “true” subtilisins, comprises the “classical” subtilisins, such as subtilisin 168 (BSS168), subtilisin BPN′, subtilisin Carlsberg (ALCALASE®, NOVOZYMES A/S), and subtilisin DY (BSSDY). A further subgroup of the subtilases, I-S2 or high alkaline subtilisins, is recognized by Siezen et al. (supra). Sub-group I-S2 proteases are described as highly alkaline subtilisins and comprises enzymes such as subtilisin PB92 (BAALKP) (MAXACAL®, Genencor International Inc.), subtilisin 309 (SAVINASE®, NOVOZYMES A/S), subtilisin 147 (BLS147) (ESPERASE®, NOVOZYMES A/S), and alkaline elastase YaB (BSEYAB). BPN′ is subtilisin BPN′ from B. amyloliquefaciens BPN′ has the amino acid sequence SEQ ID NO: 5. An increasing number of commercially used proteases are protein engineered variants of naturally occurring wild type proteases, 5 e.g., Everlase®, Relase®, Ovozyme®, Polarzyme®, Liquanase®, Liquanase Ultra® and Kannase® (Novozymes A/S), Purafast®, Purafect OXP®, FN3®, FN4® and Excellase® (Genencor International Inc.) and BLAP (FIG. 29, U.S. Pat. No. 5,352,604) (Henkel AG & Co. KGaA). The amino acid sequence of subtilisin BPN′ is described below:

Amino Acid Sequence of Subtilisin BPN′

AQSVPYGVSQIKAPALHSQG
YTGSNVKVAVIDSGIDSSHP
DLKVAGGASMVPSETNPFQD
NNSHGTHVAGTVAALNNSIG
VLGVAPSASLYAVKVLGADG
SGQYSWIINGIEWAIANNMD
VINMSLGGPSGSAALKAAVD
KAVASGVVVVAAAGNEGTSG
SSSTVGYPGKYPSVIAVGAV
DSSNQRASFSSVGPELDVMA
PGVSIQSTLPGNKYGAYNGT
SMASPHVAGAAALILSKHPN
WTNTQVRSSLENTTTKLGDS
FYYGKGLINVQAAAQ

Thus, in one aspect of the invention concerns a clear and/or colorless non-aqueous liquid detergent composition comprising

25 to 70 wt % nonionic surfactant
5 to 40 wt % polyol
0 to 15 wt % water, and
at least 0.1 wt % protease and an anionic surfactant; wherein the anionic surfactant is included in an amount of at least 0.1 g anionic surfactant per g total enzyme protein in the detergent composition.

The protease maybe selected from any of the above. In a particularly preferred aspect of the invention the protease is Savinase.

### Haze and Turbidity

Turbidity is defined as the cloudiness or haziness of a fluid, such as a detergent. Turbidity or haze (or haziness) is scattering of light by a medium, which results into cloudy appearance, and poorer clarity of objects when viewing through that. The medium can be anything like fluids or plastics etc. In particular the present invention addresses the problems of haze or turbidity in a liquid detergent comprising at least one enzyme. The turbidity is caused by individual particles (suspended solids) that are generally invisible to the naked eye. These particles scatter incoming light and turbidity can be measured by using an instrument called a nephelometer with the detector setup to the side of the light beam, as described in Example 1 of the present invention. More light reaches the detector if there are lots of small particles scattering the source beam than if there are few. The units of turbidity from a calibrated nephelometer are called Nephelometric Turbidity Units (NTU). A clear composition or a clear detergent composition is defined as a detergent composition having turbidity less than approximately 25 NTU when measured as described in Example 1.

The detergent composition of the present invention is clear and/or colorless thus the present invention concerns a clear and/or colorless non-aqueous liquid detergent composition comprising

A clear and/or colorless non-aqueous liquid detergent composition comprising

25 to 70 wt % nonionic surfactant
5 to 40 wt % polyol
0 to 15 wt % water, and
at least 0.1 wt % enzyme and an anionic surfactant; wherein the anionic surfactant is included in an amount of at least 0.1 g anionic surfactant per g total enzyme protein in the detergent composition, wherein the detergent composition has a turbidity less than 25 NTU, such as less than 24 NTU, such as less than 23 NTU, such as less than 22 NTU, such as less than 21 NTU, such as less than 20 NTU, such as less than 19 NTU, such as less than 18 NTU, such as less than 17 NTU, such as less than 16 NTU, such as less than 15 NTU, such as less than 14 NTU, such as less than 13 NTU, such as less than 12 NTU, such as less than 11 NTU, such as less than 10 NTU, such as less than 9 NTU, such as less than 8 NTU, such as less than 7 NTU, such as less than 6 NTU, such as less than 5 NTU, such as less than 4 NTU, such as less than 3 NTU, such as less than 2 NTU or even less than 1 NTU.

### Color

In addition to being clear the detergent composition according to the invention may be colorless. An observer perceives color when a light source strikes an object, which may be in the form of a solid, liquid, or gas. Objects can modify light due to inherent properties of the materials or due to added colorants, such as pigments or dyes. Some chemical constituents in the object selectively absorb some wavelengths of the incident light while reflecting or transmitting other wavelengths. The amount of reflected or transmitted light at each wavelength can be quantified using a special instrument, such as a colorimeter or spectrophotometer.

A colorless detergent composition is defined as a detergent composition having a* and b* values less than approximately +/−4 units on the CIE L*a*b*, or CIELAB, color scale. A positive a* value indicates a red color, while a negative a* value indicates a green color. An a* value of zero indicates that there is no color in the red/green color space. Similarly, a positive b* value indicates a yellow color, while a negative b* value indicates a blue color. A b* value of zero indicates that there is no color in the yellow/blue color space. Hence, there is no color if both a* and b* equal zero. Acceptable color differences (i.e. delta a* and b*) vary depending on the application, and we have found that for this application delta values of ±4 a* and/or b* units from zero are suitable to define what is colorless. In other words, practically speaking, it is difficult to perceive color up to approximately a* and/or b* equal to zero ±4 units.

Thus, in one aspect of the invention the detergent composition is a detergent composition in which a* and b* is between −4 and +4, when measured on the CIELAB color scale. The acceptable a* and b* values to provide a colorless solution should be less than ±4 units, or less than ±3 units, or less than ±2 units, or even less than ±1 unit.

### Surfactants

Surfactants are compounds that lower the surface tension of a liquid, the interfacial tension between two liquids, or that between a liquid and a solid. Surfactants may act as detergents, wetting agents, emulsifiers, foaming agents, and dispersants.

A typical type of anionic surfactant is the class of alkylbenzenesulfonates. The alkylbenzene portion of these anions is lipophilic and the sulfonate is hydrophilic. Two varieties have been popularized, those with branched alkyl groups and those with linear alkyl groups. Cationic surfactants are similar to the anionic ones, with a hydrophobic component, but, instead of the anionic sulfonate group, the cationic surfactants have quaternary ammonium as the polar end. The ammonium center is positively charged.

Non-ionic surfactants are characterized by their uncharged, hydrophilic headgroups. Typical non-ionic detergents are based on polyoxyethylene or a glycoside. Common examples of the former include Tween, Triton, and the Brij series. These materials are also known as ethoxylates or PEGylates. Glycosides have a sugar as their uncharged hydrophilic headgroup. Examples include octyl-thioglucoside and maltosides. HEGA and MEGA series detergents are similar, possessing a sugar alcohol as headgroup.

A liquid detergent of the present invention contains from 20 to 70 wt % nonionic in addition to 5 to 20 wt % alcohol, 5 to 20 wt % polyol, 0 to 10% water, and as a liquid detergent base. When enzyme is added the solution might become hazy as described above. However, adding a small amount of anionic surfactant as a co-surfactant surprisingly produced a clear solution.

Suitable anionic surfactants are soaps and those containing sulfate or sulfonate groups. Surfactants of the sulfonate type that come into consideration are (C9-C13-alkyl) benzenesulfonates and olefinsulfonates, the latter being understood to be mixtures of alkenesulfonates and hydroxyalkanesulfonates and disulfonates, as obtained, for example, by sulfonation of C12-C18 monoolefins having a terminally or internally located double bond. Also suitable are (C12-C18) alkanesulfonates and esters of alpha-sulfo fatty acids (ester sulfonates), for example the alpha-sulfonated methyl esters of hydrogenated coconut, palm kernel or tallow fatty acids a alpha-sulfocarboxylic acids resulting from saponification of MES may be used. Further suitable anionic surfactants are sulfonated fatty acid glycerol esters comprising mono-, di- and tri-esters and mixtures thereof.

Alk(en)yl sulfates to which preference is given are the alkali metal salts and the sodium salts of sulfuric acid monoesters of C12-C18 fatty alcohols, for example from coconut fatty alcohol, tallow fatty alcohol, lauryl, myristyl, cetyl or stearyl alcohol, or of C10-C20 oxo alcohols and sulfuric acid monoesters of secondary alcohols having that chain length. From the point of view of washing technology, special preference is given to C12-C16 alkyl sulfates and C12-C15 alkyl sulfates and also to C14-C15 alkyl sulfates. Suitable anionic surfactants are also alkane-2,3-diylbis (sulfates) that are prepared, for example, in accordance with U.S. Pat. No. 3,234,258 or U.S. Pat. No. 5,075,041.

Also suitable are the sulfuric acid monoesters of straight-chain or branched C7-C21 alcohols ethoxylated with from 1 to 6 mole of ethylene oxide, such as 2-methyl-branched C9-C11 alcohols with, on average, 3.5 mole of ethylene oxide (EO) or C12-C18 fatty alcohols with from 1 to 4 EO.

Anionic surfactants may also include diesters, and/or salts of monoesters, of sulfosuccinic acid with C8-C18 fatty alcohol residues or mixtures thereof. Special preference is given to sulfosuccinates in which the fatty alcohol residues have a narrow chain length distribution. It is likewise also possible to use alk(en)yl sulfosuccinates having preferably from 8 to 18 C-atoms in the alk(en)yl chain, or salts thereof.

Further anionic surfactants that come into consideration are fatty acid derivatives of amino acids, for example of methyltaurine (taurides) and/or of methylglycine (sarcosides). Further anionic surfactants that come into consideration are soaps. Saturated fatty acid soaps such as the salts of lauric acid, myristic acid, palmitic acid, stearic acid, hydrogenated erucic acid and behenic acid and soap mixtures derived from natural fatty acids, for example coconut, palm kernel or tallow fatty acids. The anionic surfactants, including the soaps, may be present in the form of their sodium, potassium or ammonium salts and in the form of soluble salts of organic bases such as mono-, di- or triethanolamine. The anionic surfactants may be present in the form of their sodium or potassium salts.

In one aspect of the invention, the anionic is selected from the group consisting of alkyl sulphates, alkyl ether sulfates and alkyl carboxylates. The length of the hydrophobic carbon chain of the anionic surfactant can range from C6-C22, or from C8-C20, or from C10-18. Either pure anionic surfactants or mixtures of anionic surfactants of varying carbon chain lengths and/or anionic surfactant types may be used. In another preferred aspect of the invention the anionic surfactant is a C10-C18 alcohol sulfate, such as a C10-C16 or a C12-C18. In another preferred aspect of the invention the surfactant is a C10-C18 sulfate, such as a C14-C16 or C12-C18. In yet another aspect of the invention the surfactant is a C10-C14 carboxylate, such as a C10 carboxylate.

Thus, a preferred aspect of the invention concerns detergent compositions according to the invention wherein the anionic surfactant is selected from the group consisting of alkyl sulphates, alkyl ether sulfates and alkyl carboxylates. Even more preferred anionic detergents include sodium laureth sulfate 2EO (Steol CS-270, Stepan), sodium laureth sulfate 3EO (Steol CS-370, Stepan), sodium laureth sulfate 3 EO (Steol CS-460, Stepan), sodium laureth sulfate 2EO (Texapon N 70 NA, BASF), sodium coco sulfate (Stepanol DCFAS-N, Stepan), sodium dodecyl sulfate (Stepanol LCP, Stepan), sodium decanoate (Sigma-Aldrich), sodium dodecanoate (Sigma-Aldrich), sodium decyl sulfate (Sigma-Aldrich), sodium dodecyl sulfate (Sigma-Aldrich), sodium tetradecyl sulfate (Sigma-Aldrich), and sodium dodecyl sulfate (EMD Chemicals).

The amount of anionic surfactant is at least 0.1 g pr g total enzyme protein in the liquid detergent composition. In a preferred aspect of the invention the anionic surfactant is included in a ratio of at least 0.1 g anionic surfactant per g total enzyme protein in the detergent composition. The ratio of anionic surfactant/total enzyme protein in the detergent is preferably at least 0.2 g/g total enzyme protein, such as at least 0.3 g/g total enzyme protein, such as at least 0.4 g/g total enzyme protein, such as at least 0.5 g/g total enzyme protein, such as at least 0.6 g/g total enzyme protein, such as at least 0.7 g/g total enzyme protein, such as at least 0.8 g/g total enzyme protein, such as at least 0.9 g/g total enzyme protein, such as at least 1 g/g total enzyme protein, such as at least 1.1 g/g total enzyme protein, such as at least 1.2 g/g total enzyme protein, such as at least 1.3 g/g total enzyme protein, such as at least 1.4 g/g total enzyme protein, such as at least 1.5 g/g total enzyme protein, such as at least 1.6 g/g total enzyme protein, such as at least 1.7 g/g total enzyme protein, such as at least 1.8 g/g total enzyme protein, such as at least 1.9 g/g total enzyme protein, such as at least 2 g/g total enzyme protein.

A clear and/or colorless non-aqueous liquid detergent composition comprising

25 to 70 wt % nonionic surfactant
5 to 40 wt % polyol
0 to 15 wt % water, and
at least 0.1 wt % enzyme and an anionic surfactant; wherein the anionic surfactant is included in an amount of at least 0.1 g anionic surfactant per g total enzyme protein in the detergent composition. In another aspect the invention concerns a clear and/or colorless non-aqueous liquid detergent composition comprising

A clear and/or colorless non-aqueous liquid detergent composition comprising

25 to 70 wt % nonionic surfactant
5 to 40 wt % polyol
0 to 15 wt % water, and
at least 0.1 wt % enzyme and an anionic surfactant; wherein the anionic surfactant is included in an amount of at least 0.2 g/g total enzyme protein, such as at least 0.3 g/g total enzyme protein, such as at least 0.4 g/g total enzyme protein, such as at least 0.5 g/g total enzyme protein, such as at least 0.6 g/g total enzyme protein, such as at least 0.7 g/g total enzyme protein, such as at least 0.8 g/g total enzyme protein, such as at least 0.9 g/g total enzyme protein, such as at least 1 g/g total enzyme protein, such as at least 1.1 g/g total enzyme protein, such as at least 1.2 g/g total enzyme protein, such as at least 1.3 g/g total enzyme protein, such as at least 1.4 g/g total enzyme protein, such as at least 1.5 g/g total enzyme protein, such as at least 1.6 g/g total enzyme protein, such as at least 1.7 g/g total enzyme protein, such as at least 1.8 g/g total enzyme protein, such as at least 1.9 g/g total enzyme protein, such as at least 2 g/g total enzyme protein in the detergent.

The amount of anionic surfactant may also be defined as a molar ratio of anionic surfactant and enzyme. Thus in one aspect of the invention the amount of anionic surfactant included in the detergent composition according to the invention corresponds to at least 200 mol anionic surfactant pr mol enzyme. In a preferred aspect of the invention the amount of anionic surfactant added to the detergent composition according to the invention corresponds to at least 300 mol anionic surfactant/mol enzyme, such as at least 400 mol/mol enzyme, such as at least 500 mol/mol enzyme, such as at least 600 mol/mol enzyme, such as at least 700 mol/mol enzyme, such as at least 800 mol/mol enzyme, such as at least 900 mol/mol enzyme, such as at least 1000 mol/mol enzyme, such as at least 1100 mol/mol enzyme, such as at least 1200 mol/mol enzyme, such as at least 1300 mol/mol enzyme, such as at least 1400 mol/mol enzyme, such as at least 1500 mol/mol enzyme, such as at least 1600 mol/mol enzyme, such as at least 1700 mol/mol enzyme, such as at least 1800 mol/mol enzyme, such as at least 1900 mol/mol enzyme or such as at least 2000 mol/mol enzyme.

Thus, one aspect of the invention concerns a clear and/or colorless non-aqueous liquid detergent composition comprising

25 to 70 wt % nonionic surfactant
5 to 40 wt % polyol
0 to 15 wt % water, and
at least 0.1 wt % protease and an anionic surfactant wherein the anionic surfactant is included in an amount of at least 200 mol anionic surfactant/mol enzyme in the detergent composition. In another aspect the invention concerns a clear and/or colorless non-aqueous liquid detergent composition comprising
25 to 70 wt % nonionic surfactant
5 to 40 wt % polyol
0 to 15 wt % water, and
at least 0.1 wt % protease and an anionic surfactant wherein the anionic surfactant is included in an amount of at least 300 mol anionic surfactant/mol enzyme, such as at least 400 mol/mol enzyme, such as at least 500 mol/mol enzyme, such as at least 600 mol/mol enzyme, such as at least 700 mol/mol enzyme, such as at least 800 mol/mol enzyme, such as at least 900 mol/mol enzyme, such as at least 1000 mol/mol enzyme, such as at least 1100 mol/mol enzyme, such as at least 1200 mol/mol enzyme, such as at least 1300 mol/mol enzyme, such as at least 1400 mol/mol enzyme, such as at least 1500 mol/mol enzyme, such as at least 1600 mol/mol enzyme, such as at least 1700 mol/mol enzyme, such as at least 1800 mol/mol enzyme, such as at least 1900 mol/mol enzyme or such as at least 2000 mol/mol enzyme in the detergent composition.

Finally, the amount of anionic surfactant may be defined on a mass basis of active components. Preparations of anionic surfactants will have some component of the active ingredient (i.e. anionic surfactant), with the remainder including other components such as diluents, solvents, processing aids, or other various components. The term active component refers specifically to the concentration of anionic surfactant in the surfactant preparation. Thus in one aspect of the invention the amount of anionic surfactant is 2 mg pr mg total enzyme protein in the detergent composition of the invention. In a preferred embodiment the amount of anionic surfactant is at least 3 mg/mg total enzyme protein, such as at least 4 mg/mg total enzyme protein, such as at least 5 mg/mg total enzyme protein, such as at least 6 mg/mg total enzyme protein, such as at least 7 mg/mg total enzyme protein, such as at least 8 mg/mg total enzyme protein, such as at least 9 mg/mg total enzyme protein, such as at least 10 mg/mg total enzyme protein, such as at least 11 mg/mg total enzyme protein, such as at least 12 mg/mg total enzyme protein, such as at least 13 mg/mg total enzyme protein, such as at least 14 mg/mg total enzyme protein, such as at least 15 mg/mg total enzyme protein, such as at least 16 mg/mg total enzyme protein, such as at least 17 mg/mg total enzyme protein, such as at least 18 mg/mg total enzyme protein, such as at least 19 mg/mg total enzyme protein or such as at least 20 mg/mg total enzyme protein.

Thus, one aspect of the invention concerns a clear and/or colorless non-aqueous liquid detergent composition comprising

25 to 70 wt % nonionic surfactant
5 to 40 wt % polyol
0 to 15 wt % water, and
at least 0.1 wt % protease and an anionic surfactant; wherein the anionic surfactant is included in an amount of at least 3 mg/mg total enzyme protein in the detergent composition. In another aspect the invention concerns a clear and/or colorless non-aqueous liquid detergent composition comprising
25 to 70 wt % nonionic surfactant
5 to 40 wt % polyol
0 to 15 wt % water, and
at least 0.1 wt % protease and an anionic surfactant wherein the anionic surfactant is included in an amount of at least 4 mg/mg total enzyme protein, such as at least 5 mg/mg total enzyme protein, such as at least 6 mg/mg total enzyme protein, such as at least 7 mg/mg total enzyme protein, such as at least 8 mg/mg total enzyme protein, such as at least 9 mg/mg total enzyme protein, such as at least 10 mg/mg total enzyme protein, such as at least 11 mg/mg total enzyme protein, such as at least 12 mg/mg total enzyme protein, such as at least 13 mg/mg total enzyme protein, such as at least 14 mg/mg total enzyme protein, such as at least 15 mg/mg total enzyme protein, such as at least 16 mg/mg total enzyme protein, such as at least 17 mg/mg total enzyme protein, such as at least 18 mg/mg total enzyme protein, such as at least 19 mg/mg total enzyme protein or such as at least 20 mg/mg total enzyme protein in the detergent composition.

### Non Aqueous Liquid Detergent Base

Enzyme and the anionic surfactant are according to the invention included in a non-aqueous liquid detergent base comprising

25 to 70 wt % nonionic surfactant
5 to 40 wt % polyol and
0 to 15 wt % water

### Nonionic Surfactant

The nonionic surfactant is typically present at a level of from about 25% to 70% by weight, such as about 30% to about 70%, or about 40% to about 70%, or about 50% to about 70% or about 60% to about 70%. The nonionic surfactant is chosen based on the desired cleaning application, and includes any conventional surfactant known in the art. Any surfactant known in the art for use in detergents may be utilized. The nonionic surfactants maybe any of the following alkoxylated, advantageously ethoxylated and/or propoxylated, especially primary alcohols having from 8 to 18 C-atoms and, on average, from 1 to 12 moles of ethylene oxide (EO) and/or from 1 to 10 moles of propylene oxide (PO) per mole of alcohol are used. Special preference is given to C8-C16 alcohol alkoxylates, advantageously ethoxylated and/or propoxylated C10-C15 alcohol alkoxylates, especially C12-C14 alcohol alkoxylates, having a degree of ethoxylation between 2 and 10, or between 3 and 8, and/or a degree of propoxylation between 1 and 6, or between 1.5 and 5. The alcohol residue may be preferably linear or, especially in the 2-position, methyl-branched, or may comprise a mixture of linear and methyl-branched chains, as are usually present in oxo alcohols. Special preference is given, however, to alcohol ethoxylates derived from linear alcohols of natural origin that contain from 12 to 18 C-atoms, for example coconut, palm and tallow fatty alcohol or oleyl alcohol, and on average from 2 to 8 EO per mole of alcohol. The ethoxylated alcohols include, for example, C12-C14 alcohols with 3 EO or 4 EO, C9-C11 alcohols with 7 EO, C13-C15 alcohols with 3 EO, 5 EO, 7 EO or 8 EO, C12-18 alcohols with 3 EO, 5 EO or 7 EO, mixtures thereof, such as mixtures of C12-C14 alcohol with 3 EO and C12-C18 alcohol with 5 EO. The mentioned degrees of ethoxylation and propoxylation represent statistical averages which, for a specific product, can be a whole number or a fractional number. Preferred alcohol ethoxylates and propoxylates have a restricted homologue distribution (narrow range ethoxylates/propoxylates, NRE/NRP). In addition to those non-ionic surfactants, fatty alcohol ethoxylates having more than 12 EO may also be used. Examples thereof are tallow fatty alcohol ethoxylate with 14 EO, 25 EO, 30 EO or 40 EO. Also suitable are alkoxylated amines, which are ethoxylated and/or propoxylated, especially primary and secondary amines having from 1 to 18 C-atoms per alkyl chain and, on average, from 1 to 12 moles of ethylene oxide (EO) and/or from 1 to 10 moles of propylene oxide (PO) per mole of amine.

In addition, as further non-ionic surfactants, there may also be used alkyl polyglycosides of the general formula R₁O(G)_{X}, wherein R₁ is a primary straight-chain or methyl-branched (especially methyl-branched in the 2-position) alkyl group having from 8 to 22, preferably from 12 to 18, C-atoms and the symbol ‘G’ indicates a glycose (monosaccharide) unit having 5 or 6 C-atoms; preferably G is glucose. The degree of oligomerisation x, which indicates the average number of glycose units, will generally lie between 1 and 10; x is preferably from 1.2 to 1.4.

A further class of used non-ionic surfactants, which are used either as sole non-ionic surfactant or in combination with other non-ionic surfactants, comprises alkoxylated, preferably ethoxylated or ethoxylated and propoxylated fatty acid alkyl esters, having from 1 to 4 C-atoms in the alkyl chain, especially fatty acid methyl esters, as described, for example, in JP58/217598.

Non-ionic surfactants of the amine oxide type, for example N-(coco alkyl)-N,N-dimethylamine oxide and N-(tallow-alkyl)-N,N-bis(2-hydroxyethyl)amine oxide, and of the fatty acid alkanolamide or ethoxylated fatty acid alkanolamide type may also be suitable.

The non-ionic surfactant may also be an alcohol ethoxylate; nonylphenol ethoxylate; alkylpolyglycoside; alkyldimethylamineoxide; ethoxylated fatty acid monoethanolamide; fatty acid monoethanolamide; fatty acid (polyhydroxyalkanol)amide; N-acyl-N-alkyl derivatives of glucosamine (“glucamides”); or any combination thereof.

In a preferred embodiment, the nonionic surfactant is an alcohol ethoxylates containing between one and five moles of ethoxylation, such as the Bio-Soft-N25-7 series.

### Polyol

The detergent may contain 5-40% by weight, such as 15-40%, 20-40%, 25-40% or 30-40% of a polyol. Any polyol including polymeric forms, such as dimmers and trimers, known in the art for use in detergents, and combinations thereof, may be utilized. The polyol (or polyhydric alcohol) may be an alcohol with two or more CH₂OH functional groups. Thus diols with two hydroxyl groups attached to separate carbon atoms in an aliphatic chain may also be used. The polyol typically includes less than 10 carbons, such as 9, 8, 7, 6, 5, 4, 3, or 2 carbons. The molecular weight is typically less than 500 g/mol, such as 400 g/mol or 300 g/mol.

Examples of suitable polyols include, but are not limited to, glycerol, propylene glycol, ethylene glycol, sorbitol, mannitol, erythritol, dulcitol, inositol, xylitol and adonitol.

The polyol may be any containing 2 to 6 carbon atoms and 2 to 6 hydroxyl groups. These polyols include ethylene glycol propylene glycol and glycerol. Glycerol and propylene glycol are particularly preferred.

The liquid detergent base may further contain additional components including but limited to those listed below.

### Builder

The detergent may further comprise other components such as about 0% to about 50% of a detergent builder or co-builder, or a mixture thereof. The builder and/or co-builder may particularly be a chelating agent that forms water-soluble complexes with Ca and Mg. Any builder and/or co-builder known in the art for use in detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), iminodiethanol (DEA) and 2,2′,2″-nitrilotriethanol (TEA), and carboxymethylinulin (CMI), and combinations thereof.

The detergent composition may also contain 0-50% by weight, such as about 0 to about 25%, of a detergent co-builder, or a mixture thereof. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), etheylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid) (HEDP), ethylenediaminetetrakis(methylene)tetrakis(phosphonic acid) (EDTMPA), diethylenetriaminepentakis(methylene)pentakis(phosphonic acid) (DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic 5 acid (PHDA), anthranilic acid-N,N-diacetic acid (ANDA), sulfanilic acid-N, N-diacetic acid (SLDA), taurine-N,N-diacetic acid (TUDA) and sulfomethyl-N,N-diacetic acid (SMDA), N-(hydroxyethyl)-ethylidenediaminetriacetate (HEDTA), diethanolglycine (DEG), Diethylenetriamine Penta (Methylene Phosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Bleach Systems

The detergent may contain 0-50% by weight of a bleaching system. Any bleaching system known in the art for use in detergents may be utilized. Suitable bleaching system components include bleaching catalysts, photobleaches, bleach activators, sources of hydrogen peroxide such as sodium percarbonate and sodium perborates, preformed peracids and mixtures thereof. Suitable preformed peracids include, but are not limited to, peroxycarboxylic acids and salts, percarbonic acids and salts, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. By Bleach activator is meant herein a compound which reacts with peroxygen bleach like hydrogen peroxide to form a peracid. The peracid thus formed constitutes the activated bleach. Suitable bleach activators to be used herein include those belonging to the class of esters amides, imides or anhydrides. Suitable examples are tetracetyl athylene diamine (TAED), sodium 3,5,5 trimethyl hexanoyloxybenzene sulphonat, diperoxy dodecanoic acid, 4-(dodecanoyloxy) benzenesulfonate (LOBS), 4-(decanoyloxy)benzenesulfonate, 4-(decanoyloxy)benzoate (DOBS), 4-(3,5,5-trimethylhexanoyloxyl)benzenesulfonate (ISONOBS), tetraacetylethylenediamine (TAED) and 4-(nonanoyloxy)benzenesulfonate (NOBS), and/or those disclosed in WO 98/17767. A particular family of bleach activators of interest was disclosed in EP 624154 and particularly preferred in that family is acetyl triethyl citrate (ATC). ATC or a short chain triglyceride like Triacin has the advantage that it is environmental friendly as it eventually degrades into citric acid and alcohol. Furthermore acethyl triethyl citrate and triacetin has a good hydrolytical stability in the product upon storage and it is an efficient bleach activator. Finally ATC provides a good building capacity to the laundry additive. Alternatively, the bleaching system may comprise peroxyacids of, for example, the amide, imide, or sulfone type. The bleaching system may also comprise peracids such as 6-(phthaloylamino)percapronic acid (PAP). The bleaching system may also include a bleach catalyst. In some embodiments the bleach component may be an organic catalyst selected from the group consisting of organic catalysts having the following formulae:

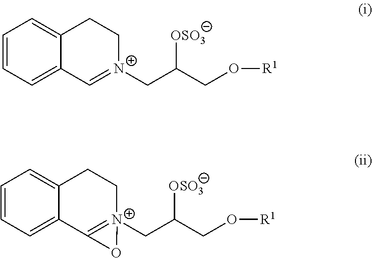

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Other exemplary bleaching systems are described, e.g., in WO 2007/087258, WO 2007/087244, WO 2007/087259, WO 2007/087242. Suitable photobleaches may for example be sulfonated zinc phthalocyanine

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of polyethylene terephthalate and polyoxyethene terephthalate (PET-POET), PVP, poly(vinylimidazole) (PVI), poly(vinylpyridin-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Enzymes

The detergent composition may comprise one or more additional enzymes such as an additional protease, lipase, cutinase, an amylase, carbohydrase, cellulase, pectinase, mannanase, arabinase, galactanase, xylanase, oxidase, e.g., a laccase, and/or peroxidase. In general the properties of the selected enzyme(s) should be compatible with the selected detergent, (i.e., pH-optimum, compatibility with other enzymatic and non-enzymatic ingredients, etc.), and the enzyme(s) should be present in effective amounts.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in, for example, WO 92/19709 and WO 92/19708 or the enzymes may be stabilized using peptide aldehydes or ketones such as described in WO 2005/105826 and WO 2009/118375.

The enzyme may also be incorporated in the detergent formulations disclosed in WO 97/07202, which is hereby incorporated by reference.

Cellulases:

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having color care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include Celluzyme™, and Carezyme™ (Novozymes A/S), Clazinase™, and Puradax HA™ (Genencor International Inc.), and KAC-500(B)™ (Kao Corporation).

Lipases and Cutinases:

Suitable lipases and cutinases include those of bacterial or fungal origin. Chemically modified or protein engineered mutants are included.

Examples include lipase from Thermomyces, e.g., from T. lanuginosus (previously named Humicola lanuginosa) as described in EP 258 068 and EP 305 216, cutinase from Humicola, e.g. H. insolens as described in WO 96/13580, a Pseudomonas lipase, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g., from B. subtilis (Dartois et al., 1993, Biochemica et Biophysica Acta, 1131: 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079, WO 97/07202, WO 00/060063, WO 2007/087508 and WO 2009/109500.

Preferred commercially available lipase enzymes include Lipolase™, Lipolase Ultra™, and Lipex™; Lecitase™, Lipolex™; Lipoclean™, Lipoprime™ (Novozymes A/S). Other commercially available lipases include Lumafast (Genencor International Inc.); Lipomax (Gist-Brocades/Genencor International Inc.) and Bacillus sp lipase from Solvay.

Amylases:

Suitable amylases (α and/or β) include those of bacterial or fungal origin. Chemically modified or protein engineered mutants are included. Amylases include, for example, α-amylases obtained from Bacillus, e.g., a special strain of Bacillus licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are Duramyl™, Termamyl™, Fungamyl™ and BAN™ (Novozymes A/S), Rapidase™ and Purastar™ (from Genencor International Inc.).

Peroxidases/Oxidases:

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

### Method and Uses

The invention further concerns a method of producing a clear and colorless liquid detergent composition wherein said method comprising: adding at least one enzyme and at least one anionic surfactant to a non-aqueous liquid detergent; wherein the anionic surfactant is added in an amount of at least 0.1 g added anionic surfactant per g total enzyme protein in the detergent composition.

In a preferred aspect, the method concerns producing a clear and/or colorless liquid detergent composition wherein said method comprising: adding at least one enzyme and at least one anionic surfactant to a non-aqueous liquid detergent comprising

25 to 70 wt % nonionic surfactant
5 to 40 wt % polyol
0 to 15 wt % water; wherein the anionic surfactant is added in an amount of least 0.1 g anionic surfactant per g total enzyme protein in the detergent composition. In a preferred aspect the enzyme is a protease and in an even more preferred aspect the enzyme is Savinase.

The anionic surfactant may be any anionic surfactant. In a preferred aspect of the invention the anionic surfactant is selected from the group consisting of alkyl sulphates, alkyl ether sulfates and alkyl carboxylates. Even more preferred anionic detergents include sodium laureth sulfate 2EO (Steol CS-270, Stepan), sodium laureth sulfate 3EO (Steol CS-370, Stepan), sodium laureth sulfate 3 EO (Steol CS-460, Stepan), sodium laureth sulfate 2EO (Texapon N 70 NA, BASF), sodium coco sulfate (Stepanol DCFAS-N, Stepan), sodium dodecyl sulfate (Stepanol LCP, Stepan), sodium decanoate (Sigma-Aldrich), sodium dodecanoate (Sigma-Aldrich), sodium decyl sulfate (Sigma-Aldrich), sodium dodecyl sulfate (Sigma-Aldrich), sodium tetradecyl sulfate (Sigma-Aldrich), and sodium dodecyl sulfate (EMD Chemicals).

The invention further concerns the use of an anionic surfactant to solubilizing an enzyme preferably a protease, such as Savinase, wherein the anionic surfactant is added to a non-aqueous liquid detergent solution in an amount of at least 0.1 g anionic surfactant per g total enzyme protein in the detergent composition.

### EXAMPLES

### Materials and Methods

The detergent formula was prepared according to the recipe provided in Table 1. The formulation was made by adding the specified amount of nonionic surfactant, Bio-Soft N25-7, to a 50 ml glass beaker at room temperature, followed by propylene glycol, glycerol, and water using a magnetic stir bar to provide adequate agitation.

### Detergent G

TABLE 1

| Ingredient | Concentration (% w/w) |
|---|---|
| Bio-Soft-N25-7 | 67.0 |
| Propylene glycol | 15.0 |
| Glycerol | 10.0 |
| Water | 8.0 |
| Total | 100 |

### Example 1

Detergent G was prepared according to the recipe as described above. The formulations were made by adding the specified amount of nonionic surfactant to a 50 mL glass beaker at room temperature, followed by propylene glycol, glycerol, and water using a magnetic stir bar to provide adequate agitation. Savinase (SEQ ID NO: 1) (Savinase Ultra 16 L, commercially available from Novozymes A/S) was added at 2.5% to the detergent, and the detergent immediately became cloudy. Next, 2.5% sodium dodecyl sulfate (SDS) was added and the detergent immediately became clear, demonstrating that anionic co-surfactant has the ability to make the solution turn from hazy to clear. SEQ ID NO: 1 is described below:

SEQ ID NO: 1
AQSVPWGISRVQAPAAHNRG
LTGSGVKVAVLDTGISTHPD
LNIRGGASFVPGEPSTQDGN
GHGTHVAGTIAALNNSIGVL
GVAPSAELYAVKVLGASGSG
SVSSIAQGLEWAGNNGMHVA
NLSLGSPSPSATLEQAVNSA
TSRGVLVVAASGNSGAGSIS
YPARYANAMAVGATDQNNNR
ASFSQYGAGLDIVAPGVNVQ
STYPGSTYASLNGTSMATPH
VAGAAALVKQKNPSWSNVQI
RNHLKNTATSLGSTNLYGSG
LVNAEAATR

Detergent G was brought forward for further exploration, following the Experimental Plan summarized in Table 2. A basis of 20 g total detergent was used for the full detergent formulation. SDS was added in powder form to the detergents at the concentration specified. After the SDS was fully incorporated into solution (approximately 15 minutes), the Savinase 16 L was added.

Various levels of SDS were tested, including 0%, 0.625%, 1.25%, 2.50% and 3.75%. The addition of SDS within the tested range does not affect the visual aesthetics, i.e., the samples remain clear and colorless. The effect of the protease Savinase was explored at a concentration 2.5%. All of the detergent samples remained clear after the incorporation of Savinase, with the exception of the lowest two levels of SDS (0% and 0.625%).

The turbidity of the samples was measured in NTU (Nephelometric Turbidity Units) using a TB300-IR Turbidimeter (Orbeco-Hellige, Sarasota, Fla.) calibrated between 0 and 800 NTU.

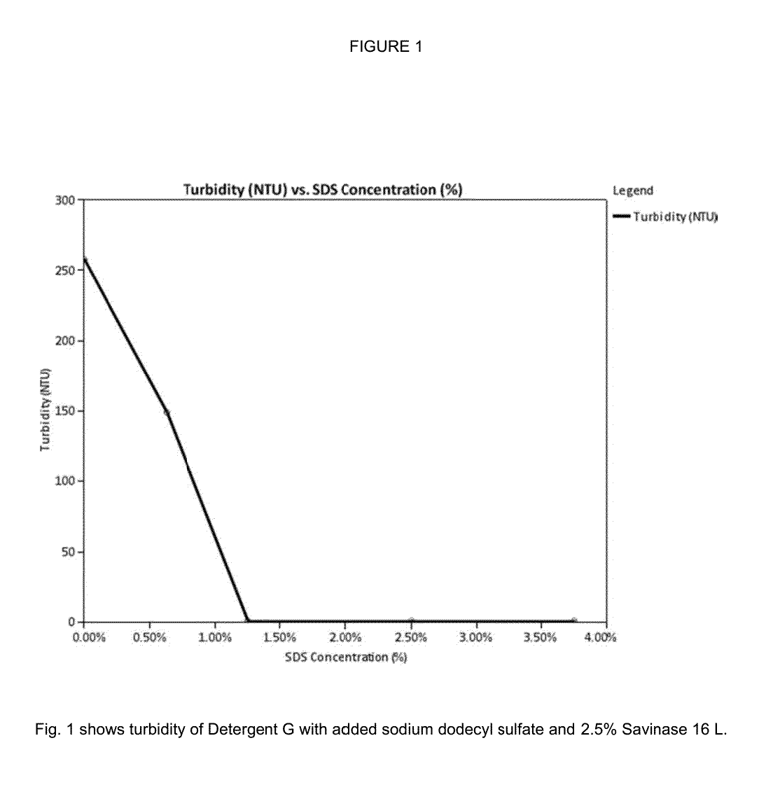

The results of the turbidity analysis are shown in Table 2 and plotted in FIG. 1. A result of less than approximately 20 NTU is not visually detectable and indicates that there is insignificant amount of haze. It can be seen from the plot that approximately 1.25% SDS is the minimum concentration needed to ensure good solubility of the 2.5% Savinase 16 L.

TABLE 2

| | | | | | Co- | |
|---|---|---|---|---|---|---|
| | | | Protease | Co- | Surfactant | |
| | Detergent | Protease | Dose | Surfactant | Powder | Turbidity |
| Sample | Base | Type | (%) | Name | (%) | (NTU) |
| 124 | Model | None | 0.00% | None | 0.00% | 0.26 |
| | Detergent G | | | | | |
| 125 | Model | Savinase | 2.50% | None | 0.00% | 258 |
| | Detergent G | 16 L | | | | |
| 126 | Model | Savinase | 2.50% | Sodium | 1.25% | 0.79 |
| | Detergent G | 16 L | | Dodecyl | | |
| | | | | Sulfate | | |
| 127 | Model | Savinase | 2.50% | Sodium | 2.50% | 0.53 |
| | Detergent G | 16 L | | Dodecyl | | |
| | | | | Sulfate | | |
| 128 | Model | Savinase | 2.50% | Sodium | 3.75% | 0.48 |
| | Detergent G | 16 L | | Dodecyl | | |
| | | | | Sulfate | | |
| 134 | Model | Savinase | 2.50% | Sodium | 0.625% | 149 |
| | Detergent G | 16 L | | Dodecyl | | |
| | | | | Sulfate | | |

### Example 2

Having shown that SDS can make a cloudy solution clear in the case of non-aqueous enzymatic detergent formulas, other anionic surfactants have also been identified which reduce the turbidity of the non-aqueous enzymatic detergent formula, including those of the alkyl sulfate, alkyl ether sulfate, and alkyl carboxylate classes.

For this example, detergent G was prepared according to the recipe outlined in Table 1. The ingredients were added in the order listed, beginning with nonionic surfactant, using moderate agitation at room temperature.

Detergent G alone is visibly very clear with a correspondingly low turbidity value of 0.3 NTU, and it is visibly colorless having Hunter a* and b* values of −0.47 and 2.06, respectively.

This example is focused on studying the effect of a various anionic co-surfactants, and anionic surfactants of varying carbon chain lengths, polar headgroups, and ethylene oxide groups were considered. A list of surfactants explored is shown in Table 3.

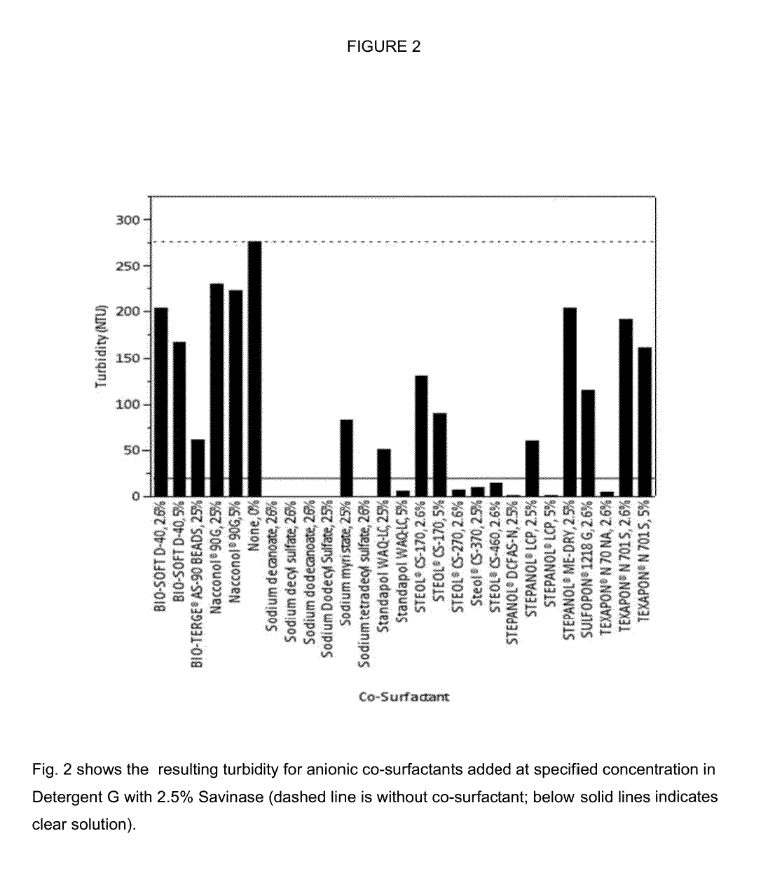

The chart shown in FIG. 2 provides an overview of the results, with a solid reference line showing the turbidity of 2.5% Savinase in the detergent without anionic co-surfactant and the dashed line indicating the point below which results in a visibly clear solution (approximately 20 NTU). In all, 12 of the 20 anionic co-surfactants explored facilitated a clear solution with Savinase in detergent G, while all 20 anionic co-surfactants caused the turbidity to be reduced. The data are shown in Table 4.

Co-surfactants yielding a clear and colorless solution with Savinase in the detergent include: sodium laureth sulfate 2EO (Steol CS-270, Stepan), sodium laureth sulfate 3EO (Steol CS-370, Stepan), sodium laureth sulfate 3 EO (Steol CS-460, Stepan), sodium laureth sulfate 2EO (Texapon N 70 NA, BASF), sodium coco sulfate (Stepanol DCFAS-N, Stepan), sodium dodecyl sulfate (Stepanol LCP, Stepan), sodium decanoate (Sigma-Aldrich), sodium dodecanoate (Sigma-Aldrich), sodium decyl sulfate (Sigma-Aldrich), sodium dodecyl sulfate (Sigma-Aldrich), sodium tetradecyl sulfate (Sigma-Aldrich), and sodium dodecyl sulfate (EMD Chemicals).

All of these surfactants produced clear solutions at the 2.5% inclusion level, with the exception of Standapol WAW-LC and Stepanol LCP, which both worked when their respective concentrations were increased to 5.0%. This again confirms the effect of anionic co-surfactant concentration on turbidity reduction demonstrated in Example 1.

TABLE 3
list of surfactants used

| | | | | | Carbon | |
|---|---|---|---|---|---|---|
| | | | | Hydrophilic | Chain | Surfactant |
| Trade Name | Category | Surfactant Type | Abv. | Group | Length | CAS |
| Standapol | Anionic | Sodium C10-16 | AS | Sulphate | 10-16 | 68585-47-7 |
| WAQ-LC | | alcohol sulfate | | | | |
| (Cognis) | | | | | | |
| Sulfopon ® | Anionic | Sodium C12-18 | AS | Sulphate | 2-18 | 68955-19-1 |
| 1218 G | | alcohol sulfate | | | | |
| (Cognis) | | | | | | |
| Texapon ® N | Anionic | Sodium laureth | SLES | Sulphate | 12 | 68585-34-2 |
| 70 NA | | sulfate, 2 EO | | | | |
| (Cognis) | | | | | | |
| Texapon ® N | Anionic | Sodium laureth | SLES | Sulphate | 12 | 68585-34-2 |
| 701 S | | sulfate, 1 EO | | | | |
| (Cognis) | | | | | | |
| Sodium | Anionic | Sodium dodecyl | AS | Sulphate | 12 | 151-21-3 |
| dodecyl | | sulfate | | | | |
| sulfate | | | | | | |
| (EMD | | | | | | |
| Chemicals) | | | | | | |
| Sodium | Anionic | Sodium | Soap | Carboxylate | 10 | 1002-62-6 |
| decanoate | | decanoate | | | | |
| (Sigma- | | | | | | |
| Aldrich) | | | | | | |
| Sodium | Anionic | Sodium decyl | AS | Sulphate | 10 | 142-87-0 |
| decyl sulfate | | sulfate | | | | |
| (Sigma- | | | | | | |
| Aldrich) | | | | | | |
| Sodium | Anionic | Sodium | Soap | Carboxylate | 12 | 629-25-4 |
| dodecanoate | | dodecanoate | | | | |
| (Sigma- | | | | | | |
| Aldrich) | | | | | | |
| Sodium | Anionic | Sodium | Soap | Carboxylate | 14 | 822-12-8 |
| myristate | | tetradecanoate | | | | |
| (Sigma- | | | | | | |
| Aldrich) | | | | | | |
| Sodium | Anionic | Sodium | AS | Sulphate | 14 | 1191-50-0 |
| tetradecyl | | tetradecyl | | | | |
| sulfate | | sulfate | | | | |
| (Sigma- | | | | | | |
| Aldrich) | | | | | | |
| Bio-Soft D- | Anionic | Sodium | LAS | Sulphonate | 12 | 68081-81-2 |
| 40 (Stepan) | | dodecylbenzene | | | | |
| | | sulfonate | | | | |
| Bio-Soft | Nonionic | Tridecyl alcohol | AE | Ethoxylate | 13 | |
| N25-7 | | ethoxylate | | | | |
| (Stepan) | | | | | | |
| Bio-Terge ® | Anionic | Sodium C14-16 | AOS | Sulphonate | 14-16 | 68439-57-6 |
| AS-90 Beads | | olefin sulfonate | | | | |
| (Stepan) | | | | | | |
| Nacconol ® | Anionic | Sodium | LAS | Sulphonate | 12 | 25155-30-0 |
| 90G (Stepan) | | dodecylbenzene | | | | |
| | | sulfonate | | | | |
| Steol ® CS- | Anionic | Sodium laureth | SLES | Sulphate | 12 | 68585-34-2 |
| 170 (Stepan) | | sulfate, 1 EO | | | | |
| Steol ® CS- | Anionic | Sodium laureth | SLES | Sulphate | 12 | 68585-34-2 |
| 270 (Stepan) | | sulfate, 2 EO | | | | |
| Steol ® CS- | Anionic | Sodium laureth | SLES | Sulphate | 12 | 9004-82-4 |
| 370 (Stepan) | | sulfate, 3 EO | | | | |
| Steol ® CS- | Anionic | Sodium laureth | SLES | Sulphate | 12 | 9004-82-4 |
| 460 (Stepan) | | sulfate, 3 EO | | | | |
| Stepanol ® | Anionic | Sodium coco | AS | Sulphate | 12-18 | 68955-19-1 |
| DCFASN | | sulfate | | | | |
| (Stepan) | | | | | | |
| Stepanol ® | Anionic | Sodium lauryl | AS | Sulphate | 12 | 151-21-3 |
| LCP | | sulfate | | | | |
| (Stepan) | | | | | | |
| Stepanol ® | Anionic | Sodium lauryl | AS | Sulphate | 12 | 151-21-3 |
| MEDRY | | sulfate | | | | |
| (Stepan) | | | | | | |

Table 4 turbidity values (NTU) for 2.5% Savinase in detergent G with various anionic co-surfactants at concentration specified (the benchmark with no co-surfactant is labeled as “None”

| Surfactant | Turbidity (NTU) |
|---|---|
| None, 0% | 277.00 |
| BIO-SOFT D-40, 2.6% | 205.00 |
| BIO-SOFT D-40, 5% | 168.00 |
| BIO-TERGE ® AS-90 BEADS, 2.5% | 63.30 |
| Methyl ester sulfonate, 2.5% | 101.00 |
| Nacconol ® 90G, 2.5% | 231.00 |
| Nacconor ® 90G, 5% | 224.00 |
| Sodium decanoate, 2.6% | 0.28 |
| Sodium decyl sulfate, 2.6% | 0.26 |
| Sodium dodecanoate, 2.6% | 0.63 |
| Sodium Dodecyl Sulfate, 2.5% | 0.40 |
| Sodium myristate, 2.5% | 84.70 |
| Sodium tetradecyl sulfate, 2.6% | 0.48 |
| Standapol WAQ-LC, 2.5% | 52.50 |
| Standapol WAQ-LC, 5% | 7.35 |
| STEOL ® CS-170, 2.6% | 132.00 |
| STEOL ® CS-170, 5% | 90.94 |
| STEOL ® CS-270, 2.6% | 8.34 |
| Steol ® CS-370, 2.5% | 10.30 |
| STEOL ® CS-460, 2.6% | 14.90 |
| STEPANOL ® DCFAS-N, 2.5% | 1.80 |
| STEPANOL ® LCP 2.5% | 61.70 |
| STEPANOL ® LCP, 5% | 2.81 |
| STEPANOL ® ME-DRY, 2.5% | 205.00 |
| SULFOPON ® 1218 G, 2.6% | 116.00 |
| TEXAPON ® N 70 NA, 2.6% | 5.55 |
| TEXAPON ® N 701 S, 2.6% | 193.00 |
| TEXAPON ® N 701 S, 5% | 163.00 |

### Example 3

Additional proteases were explored to show that this concept is robust across a range of proteases. Four of the most common proteases from the detergents industry were investigated, including Savinase (SEQ ID NO: 1), Everlase Ultra (SEQ ID NO: 2), Coronase (SEQ ID NO: 3), and Alcalase (SEQ ID NO 4). SEQ ID NO: 2, SEQ ID NO: 3 and SEQ ID NO: 4 are described below:

SEQ ID NO: 2
AQSVPWGISRVQAPAAHNRG
LTGSGVKVAVLDTGISTHPD
LNIRGGASFVPGEPSTQDGN
GHGTHVAGTIAALNNSIGVL
GVAPSAELYAVKVLGASGSG
SVSSIAQGLEWAGNNGMHVA
NLSLGSPSPSATLEQAVNSA
TSRGVLVVAASGNSGAGSIS
YPARYANAMAVGATDQNNNR
ASFSQYGAGLDIVAPGVNVQ
STYPGSTYASLNGTSSATPH
VAGAAALVKQKNPSWSNVQI
RNHLKNTATSLGSTNLYGSG
LVNAEAATR
SEQ ID NO: 3
AQSVPWGISRVQAPAAHNRG
LTGSGVKVAVLDTGISTHPD
LNIRGGASPVPGEPSTQDGN
GHGTHVAGTIAALNNSIGVL
GVAPSAELYAVKVLGASEGS
GSVSSIAQGLEWAGNNGMHV
ANLSLGSPSPSATLEQAVNS
ATSRGVLVVAASGNSGAGSI
SYPARYANAMAVGATDQNNN
RASFSQYGAGLDIVAPGVNV
QSTYPGSTYASLNGTSMATP
HVAGAAALVKQKNPSWSNVQ
IRNHLKNTATSLGSTNLYGS
GLVNAEAATR
SEQ ID NO: 4
AQTVPYGIPLIKADKVQAQG
FKGANVKVAVLDTGIQASHP
DLNVVGGASFVAGEAYNTDG
NGHGTHVAGTVAALDNTTGV
LGVAPSVSLYAVKVLNSSGS
GSYSGIVSGIEWATTNGMDV
INNSLGGASGSTAMKQAVDN
AYARGVVVVAAAGNSGSSGN
TNTIGYPAKYDSVIAVGAVD
SNSNRASFSSVGAELEVMAP
GAGVYSTYPTNTYATLNGTS
MASPHVAGAAALILSKHPNL
SASQVRNRLSSTATYLGSSF
YYGKGLINVEAAAQ

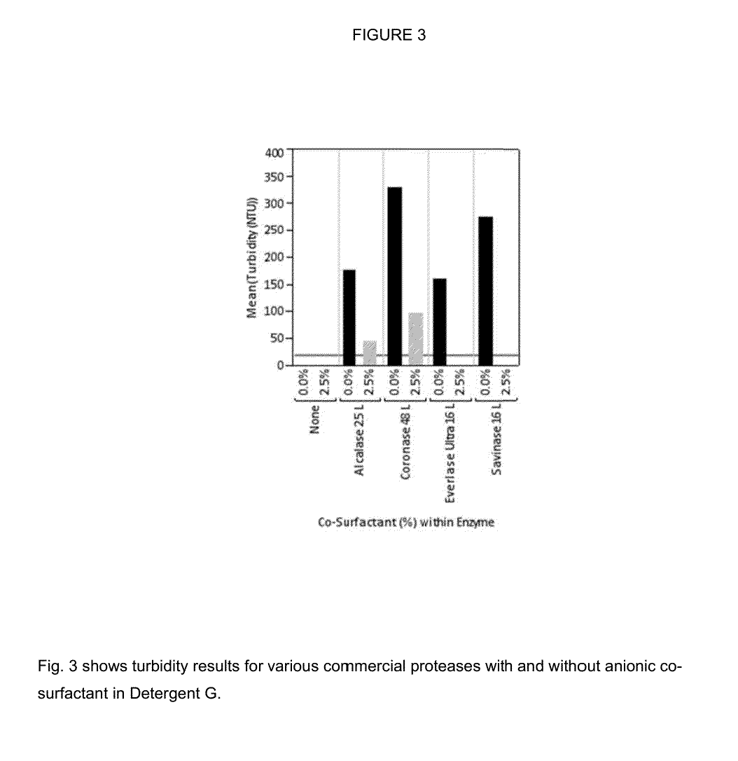

For demonstration purposes, a lab grade sample of SDS (EMD Chemicals) was added to detergent G as outlined in Table 5. A plot of the data is shown in FIG. 3. Substantial haze developed when 2.5% protease was added to the detergent without SDS; however, the SDS significantly reduced the turbidity for each of the proteases. SDS provided clear solutions for Savinase 16 L and Everlase Ultra 16 L, while significantly reducing the turbidity levels for Coronase 48 L and Alcalase 2.5 L. As shown in Example 1 the effect of anionic co-surfactant on turbidity is concentration dependent.

TABLE 5

| | | | | Co- | Co- | |
|---|---|---|---|---|---|---|
| | Detergent | | Enzyme | Surfactant | Surfactant | Turbidity |
| Sample | Base | Enzyme | Dose (%) | Name | (%) | (NTU) |
| 1 | Detergent G | None | 0.0% | None | 0.0% | 0.3 |
| 2 | Detergent G | Savinase 16 L | 2.5% | None | 0.0% | 277 |
| 3 | Detergent G | Everlase | 2.5% | None | 0.0% | 161 |
| | | Ultra 16 L | | | | |
| 4 | Detergent G | Coronase | 2.5% | None | 0.0% | 332 |
| | | 48 L | | | | |
| 5 | Detergent G | Alcalase | 2.5% | none | 0.0% | 177 |
| | | 2.5 L | | | | |
| 16 | Detergent G | None | 0.0% | Sodium | 2.5% | 0.27 |
| | | | | Dodecyl | | |
| | | | | Sulfate | | |
| 17 | Detergent G | Savinase 16 L | 2.5% | Sodium | 2.5% | 0.4 |
| | | | | Dodecyl | | |
| | | | | Sulfate | | |
| 18 | Detergent G | Everlase | 2.5% | Sodium | 2.5% | 0.29 |
| | | Ultra 16 L | | Dodecyl | | |
| | | | | Sulfate | | |
| 19 | Detergent G | Coronase | 2.5% | Sodium | 2.5% | 100 |
| | | 48 L | | Dodecyl | | |
| | | | | Sulfate | | |
| 20 | Detergent G | Alcalase | 2.5% | Sodium | 2.5% | 45.6 |
| | | 2.5 L | | Dodecyl | | |
| | | | | Sulfate | | |

### Example 4

A further aspect of this technology is that it is possible to formulate a detergent that is colorless, in addition to being clear (free of haze). Hunter color values L*, a*, and b* measured using the LabScan XE (HunterLab, Reston, Va.) can be used to assess the color of liquid samples, and it is deemed that a* and b* <±4 units is defined as being colorless. A table outlining color measurements for select detergent samples containing 2.5% Savinase 16 L and 2.5% of various anionic co-surfactants is shown in Table 6. In this data set, 9 of the 13 anionic co-surfactants yielded clear and colorless solutions with 2.5% Savinase 16 L in detergent G.

TABLE 6

| | | | Co- | | | | |
|---|---|---|---|---|---|---|---|
| | Enzyme | Co-Surfactant | Surfactant | Turbidity | | | |
| Enzyme | Dose (%) | Name | (%) | (NTU) | L* | a* | b* |
| None | 0.0% | None | 0.00% | 0.3 | 67.32 | −0.47 | 2.06 |
| Savinase 16 L | 2.6% | Nacconol ® | 5.00% | 224 | 63.47 | −0.3 | 5.71 |
| | | 90G | | | | | |
| Savinase 16 L | 2.6% | Standapol | 5.00% | 7.35 | 66.94 | −0.48 | 3.05 |
| | | WAQ-LC | | | | | |
| Savinase 16 L | 2.5% | TEXAPON ® | 2.60% | 5.55 | 66.92 | −0.46 | 2.69 |
| | | N 70 NA | | | | | |
| Savinase 16 L | 2.6% | TEXAPON ® | 5.00% | 163 | 64.56 | −0.23 | 4 |
| | | N 701 S | | | | | |
| Savinase 16 L | 2.5% | Sodium | 2.60% | 0.28 | 66.83 | −0.48 | 2.98 |
| | | decanoate | | | | | |
| Savinase 16 L | 2.5% | Sodium decyl | 2.60% | 0.26 | 66.89 | −0.45 | 2.66 |
| | | sulfate | | | | | |
| Savinase 16 L | 2.5% | Sodium | 2.60% | 0.63 | 66.71 | −0.48 | 3.04 |
| | | dodecanoate | | | | | |
| Savinase 16 L | 2.5% | Sodium | 2.60% | 0.48 | 66.92 | −0.45 | 2.75 |
| | | tetradecyl | | | | | |
| | | sulfate | | | | | |
| Savinase 16 L | 2.6% | BIO-SOFT D- | 5.00% | 168 | 64.34 | −0.25 | 4.39 |
| | | 40 | | | | | |
| Savinase 16 L | 2.6% | STEOL ® CS- | 5.00% | 90.94 | 65.78 | −0.49 | 3.69 |
| | | 170 | | | | | |
| Savinase 16 L | 2.5% | STEOL ® CS- | 2.60% | 8.34 | 66.84 | −0.45 | 2.89 |
| | | 270 | | | | | |
| Savinase 16 L | 2.5% | STEOL ® CS- | 2.60% | 14.9 | 66.9 | −0.5 | 3.12 |
| | | 460 | | | | | |
| Savinase 16 L | 2.6% | STEPANOL ® | 5.00% | 2.81 | 66.77 | −0.5 | 2.97 |
| | | LCP | | | | | |

TABLE 7
Summary of Various Formulations and Their Free and Clear Testing Results.

| | | % C12-C15 | | | | | | | | | | | | | |
|---|---|---|---|---|---|---|---|---|---|---|---|---|---|---|---|
| | | Alcohol | | | | | | | | | | | | | |
| Batch | Formula | Ethxylate | % | % | % | % | % | % | | % Coronase | | % Preferenz | | | |
| Name/Purpose | Number | 7EO | PG | WAZ | PLX | SLES | AES | Glycerin | % HP20 | Ultra | % Savinase | S100 | % Mannaway | % Carezyme | Outcome |
| Free Clear w/ | CD-1-U- | 71.560 | 9.900 | 6.700 | 0.200 | 3.000 | 0.000 | 5.000 | 1.000 | 1.000 | 0.000 | 0.000 | 0.000 | 0.000 | Overnight separated with |
| 3% SLES, 1% | 145a | | | | | | | | | | | | | | white bottom layer, taken |
| Coronase | | | | | | | | | | | | | | | off stability |
| Free Clear w/ | CD-1-U- | 70.960 | 9.900 | 6.300 | 0.200 | 3.000 | 0.000 | 5.000 | 1.000 | 2.000 | 0.000 | 0.000 | 0.000 | 0.000 | Overnight separated with |
| 3% SLES, 2% | 145a | | | | | | | | | | | | | | thick white layer at |
| Coronase | | | | | | | | | | | | | | | bottom, taken off stability |
| Free Clear w/ | CD-1-U- | 70.360 | 9.900 | 5.900 | 0.200 | 3.000 | 0.000 | 5.000 | 1.000 | 3.000 | 0.000 | 0.000 | 0.000 | 0.000 | Overnight separated with |
| 3% SLES, 3% | 145a | | | | | | | | | | | | | | thick white layer at |
| Coronase | | | | | | | | | | | | | | | bottom, taken off stability |
| Free Clear w/ | CD-1-U- | 69.760 | 9.900 | 5.500 | 0.200 | 3.000 | 0.000 | 5.000 | 1.000 | 4.000 | 0.000 | 0.000 | 0.000 | 0.000 | Overnight separated with |
| 3% SLES, 4% | 145a | | | | | | | | | | | | | | thick white layer at |
| Coronase | | | | | | | | | | | | | | | bottom, taken off stability |
| Free Clear w/ | CD-1-U- | 72.290 | 7.000 | 5.900 | 0.200 | 3.000 | 0.000 | 6.000 | 1.000 | 3.000 | 0.000 | 0.000 | 0.000 | 0.000 | Jars put in 105 F. and |
| 3% SLES, 7% | 145a | | | | | | | | | | | | | | 125 F. overnight (not full |
| PG, 3% | | | | | | | | | | | | | | | stability testing), but |
| Coronase | | | | | | | | | | | | | | | separated. Not |
| | | | | | | | | | | | | | | | compatible |
| Free Clear w/ | CD-1-U- | 71.690 | 7.000 | 5.500 | 0.200 | 3.000 | 0.000 | 6.000 | 1.000 | 4.000 | 0.000 | 0.000 | 0.000 | 0.000 | Jars put in 105 F. and |
| 3% SLES, 7% | 145a | | | | | | | | | | | | | | 125 F. overnight (not full |
| PG, 4% | | | | | | | | | | | | | | | stability testing), but |
| Coronase | | | | | | | | | | | | | | | separated. Not |
| | | | | | | | | | | | | | | | compatible |
| Free Clear w/ | CD-1-U- | 71.200 | 9.900 | 6.810 | 0.200 | 3.000 | 0.000 | 5.000 | 2.000 | 0.000 | 0.000 | 0.000 | 0.000 | 0.000 | Homogenous mixture, |
| 3% SLES, 2% | 145a | | | | | | | | | | | | | | successful on long-term |
| HP20 | | | | | | | | | | | | | | | stability |
| Free Clear w/ | CD-1-U- | 71.000 | 9.900 | 6.810 | 0.400 | 3.000 | 0.000 | 5.000 | 2.000 | 0.000 | 0.000 | 0.000 | 0.000 | 0.000 | Homogenous mixture, |
| 3% SLES, 2% | 145a | | | | | | | | | | | | | | successful on long-term |
| HP20, 0.4% | | | | | | | | | | | | | | | stability |
| PLX | | | | | | | | | | | | | | | |
| Free Clear w/ | CD-1-U- | 68.000 | 9.900 | 6.810 | 0.400 | 3.000 | 0.000 | 5.000 | 2.000 | 0.000 | 3.000 | 0.000 | 0.000 | 0.000 | Separated out after 1 |
| 3% SLES, 2% | 145a | | | | | | | | | | | | | | night into a thick wispy |
| HP20, 3% | | | | | | | | | | | | | | | white layer at bottom, |
| Savinase, 0.4% | | | | | | | | | | | | | | | taken off stability |
| PLX | | | | | | | | | | | | | | | |
| Free Clear w/ | CD-1-U- | 69.370 | 9.900 | 5.850 | 0.200 | 0.000 | 5.000 | 5.000 | 1.000 | 0.000 | 0.000 | 0.000 | 0.000 | 0.000 | Homogenous mixture, |
| 5% AES | 145a | | | | | | | | | | | | | | successful on long-term |
| | | | | | | | | | | | | | | | stability |
| Free Clear w/ | CD-1-U- | 68.370 | 9.900 | 5.600 | 0.200 | 0.000 | 5.000 | 5.000 | 2.000 | 0.000 | 0.000 | 0.000 | 0.000 | 0.000 | Homogenous mixture, |
| 5% AES, 2% | 145a | | | | | | | | | | | | | | successful on long-term |
| HP20 | | | | | | | | | | | | | | | stability |
| Free Clear for | CD-1-U- | 66.000 | 9.900 | 5.000 | 0.200 | 0.000 | 0.000 | 14.750 | 1.000 | 0.000 | 0.000 | 0.000 | 0.000 | 0.000 | This is the current |
| NonIonic | 124 | | | | | | | | | | | | | | formula. Homogenous |
| Testing | | | | | | | | | | | | | | | mixture, successful so far |
| | | | | | | | | | | | | | | | on long-term stability |
| Free Clear w/ | CD-1-U- | 65.700 | 9.900 | 7.800 | 0.200 | 0.000 | 0.000 | 14.750 | 1.000 | 0.000 | 0.000 | 0.000 | 0.300 | 0.000 | Mostly clear, but with |
| 0.3% | 124 | | | | | | | | | | | | | | “oily” substance |
| Mannaway | | | | | | | | | | | | | | | throughout when shaken |
| | | | | | | | | | | | | | | | or dripping |
| Free Clear w/ | CD-1-U- | 65.400 | 9.900 | 7.800 | 0.200 | 0.000 | 0.000 | 14.750 | 1.000 | 0.000 | 0.000 | 0.000 | 0.600 | 0.000 | Mostly clear, but with |
| 0.6% | 124 | | | | | | | | | | | | | | “oily” substance |
| Mannaway | | | | | | | | | | | | | | | throughout when shaken |
| | | | | | | | | | | | | | | | or dripping |
| Free Clear w/ | CD-1-U- | 65.100 | 9.900 | 7.800 | 0.200 | 0.000 | 0.000 | 14.750 | 1.000 | 0.000 | 0.000 | 0.000 | 0.900 | 0.000 | Too hazy in RT, F/T, and |
| 0.9% | 124 | | | | | | | | | | | | | | 40 F. Kept on stability to |
| Mannaway | | | | | | | | | | | | | | | monitor, but enzyme |
| | | | | | | | | | | | | | | | levels too high |
| Free Clear w/ | CD-1-U- | 65.700 | 9.900 | 7.800 | 0.200 | 0.000 | 0.000 | 14.750 | 1.000 | 0.000 | 0.000 | 0.000 | 0.000 | 0.300 | Mostly clear, but with |
| 0.3% | 124 | | | | | | | | | | | | | | “oily” substance |
| Carezyme | | | | | | | | | | | | | | | throughout when shaken |
| | | | | | | | | | | | | | | | or dripping |
| Free Clear w/ | CD-1-U- | 65.400 | 9.900 | 7.800 | 0.200 | 0.000 | 0.000 | 14.750 | 1.000 | 0.000 | 0.000 | 0.000 | 0.000 | 0.600 | Mostly clear, but with |
| 0.6% | 124 | | | | | | | | | | | | | | “oily” substance |
| Carezyme | | | | | | | | | | | | | | | throughout when shaken |
| | | | | | | | | | | | | | | | or dripping |
| Free Clear w/ | CD-1-U- | 65.100 | 9.900 | 7.800 | 0.200 | 0.000 | 0.000 | 14.750 | 1.000 | 0.000 | 0.000 | 0.000 | 0.000 | 0.900 | Mostly clear, but with |
| 0.9% | 124 | | | | | | | | | | | | | | “oily” substance |
| Carezyme | | | | | | | | | | | | | | | throughout when shaken |
| | | | | | | | | | | | | | | | or dripping |
| Free Clear w/ | CD-1-U- | 68.167 | 9.900 | 5.600 | 0.400 | 0.000 | 5.000 | 5.000 | 2.000 | 0.000 | 0.000 | 0.000 | 0.000 | 0.000 | Too yellow for free clear |
| 5% AES, 2% | 145a | | | | | | | | | | | | | | in almost all stability jars, |
| HP20, 0.4% | | | | | | | | | | | | | | | kept on stability to |
| PLX | | | | | | | | | | | | | | | monitor |
| Free Clear w/ | CD-1-U- | 66.000 | 9.900 | 5.000 | 0.400 | 0.000 | 0.000 | 14.750 | 1.000 | 0.000 | 0.000 | 0.000 | 0.000 | 0.000 | Homogenous mixture, |
| 0.4% PLX | 124 | | | | | | | | | | | | | | successful on long-term |
| | | | | | | | | | | | | | | | stability |
| Free Clear w/ | CD-1-U- | 64.200 | 9.900 | 7.800 | 0.200 | 0.000 | 0.000 | 14.750 | 1.000 | 0.000 | 0.000 | 0.000 | 0.900 | 0.900 | Too hazy in all jars, taken |
| 0.9% | 124 | | | | | | | | | | | | | | off stability. Possibly |
| Mannaway, | | | | | | | | | | | | | | | enzyme levels are too |
| 0.9% | | | | | | | | | | | | | | | high |
| Carezyme | | | | | | | | | | | | | | | |
| Free Clear w/ | CD-1-U- | 64.800 | 9.900 | 7.800 | 0.200 | 0.000 | 0.000 | 14.750 | 1.000 | 0.000 | 0.000 | 0.000 | 0.600 | 0.600 | Too hazy in all jars, but |
| 0.6% | 124 | | | | | | | | | | | | | | kept on stability to |
| Mannaway, | | | | | | | | | | | | | | | monitor. Also seeing |
| 0.6% | | | | | | | | | | | | | | | slight “oily” substance in |
| Carezyme | | | | | | | | | | | | | | | 105 F |
| Free Clear w/ | CD-1-U- | 65.400 | 9.900 | 7.800 | 0.200 | 0.000 | 0.000 | 14.750 | 1.000 | 0.000 | 0.000 | 0.000 | 0.300 | 0.300 | Mostly clear, but with |
| 0.3% | 124 | | | | | | | | | | | | | | “oily” substance |
| Mannaway, | | | | | | | | | | | | | | | throughout when shaken |
| 0.3% | | | | | | | | | | | | | | | or dripping in 105 F. and |
| Carezyme | | | | | | | | | | | | | | | 125 F. |
| Free Clear w/ | CD-1-U- | 65.170 | 9.900 | 5.600 | 0.400 | 0.000 | 5.000 | 5.000 | 2.000 | 0.000 | 3.000 | 0.000 | 0.000 | 0.000 | Separated out after 1 |
| 5% AES, 2% | 145a | | | | | | | | | | | | | | night into a thick wispy |
| HP20, 3% | | | | | | | | | | | | | | | white layer at bottom, |
| Savinase, 0.4% | | | | | | | | | | | | | | | taken off stability |
| PLX | | | | | | | | | | | | | | | |
| Free Clear- | CD-1-U- | 75.000 | 9.900 | 8.550 | 0.200 | 0.000 | 0.000 | 5.000 | 1.000 | 0.000 | 0.000 | 0.000 | 0.000 | 0.000 | Up for stability now, |
| 145a Formula | 145a | | | | | | | | | | | | | | results will be available |
| | | | | | | | | | | | | | | | after 1 week |
| Free Clear- | CD-1-U- | 76.200 | 9.900 | 8.600 | 0.200 | 0.000 | 0.000 | 5.000 | 0.000 | 0.000 | 0.000 | 0.000 | 0.000 | 0.000 | Up for stability now, |
| 145a Formula, | 145a | | | | | | | | | | | | | | results will be available |
| No HP20 | | | | | | | | | | | | | | | after 1 week |
| Free Clear w/ | CD-1-U- | 74.750 | 9.900 | 8.550 | 0.200 | 0.000 | 0.000 | 5.000 | 1.000 | 0.000 | 0.000 | 0.250 | 0.000 | 0.000 | After 3 days, batch had |
| 0.25% | 145a | | | | | | | | | | | | | | separated with layer on |
| Preferenz S100 | | | | | | | | | | | | | | | bottom and particulate |
| | | | | | | | | | | | | | | | matter throughout, taken |
| | | | | | | | | | | | | | | | off stability |

“%” means weight percent.
“RT” means room temperature; “F/T” means freeze and thaw.
“PG” is proplyene glycol.
“WAZ” is water.
“PLX” is Fluorescer Tinopal CBS-X SP.
“MEA” is monethanolamine.
“TEA” is triethanolamine.
“LAS” is Aklybenezene Sulfonic Acid Low DATS.
“AWC” is coconut fatty acid.
“AES” is 60% active C12-15 Alcohol Ethoxysulfate 3EO
“SLES” is 70% active C12-15 Alcohol Ethoxysulfate 3EO
“TSA” is sodium methacrylate/styrene copolymer.
“HP20” is Ploymer HP 20.

1. A clear and/or colorless non-aqueous liquid detergent composition comprising
25 to 70 wt % nonionic surfactant
5 to 40 wt % polyol
0 to 15 wt % water, and
at least 0.1 wt % enzyme and an anionic surfactant, wherein the anionic surfactant is included in an amount of at least 0.1 g anionic surfactant per g total enzyme protein in the detergent composition.

2. A detergent composition according to claim 1, wherein the amount of anionic surfactant is at least 0.2 g/g total enzyme protein, preferably at least 0.5 g/g total enzyme protein, preferably at least 1 g/g total enzyme protein, preferably at least 1.5 g/g total enzyme protein or preferably at least 2 g/g total enzyme protein.

3. A detergent composition according to any of the preceding claims, wherein the enzyme is a protease.

4. A detergent composition according to any of the preceding claims, wherein the protease is selected from Savinase, Coronase, Everlase, Alcalase, BPN′, PB92 or any variant hereof.

5. A detergent composition according to one of claims 2-4, wherein the amount of protease is between 0.1 wt to 5 wt % of the total detergent concentration.

6. A detergent composition according to any of the preceding claims, wherein the anionic surfactant is selected from the group consisting of alkyl sulphates, alkyl ether sulfates and alkyl carboxylates.

7. The detergent composition according to claim 6, wherein the anionic surfactant is selected from the group consisting of a C10-C18 alcohol sulfate, C10-C18 sulfate and C10-C14 carboxylate.

8. A detergent composition according to any of the preceding claims, wherein the total amount of water in the detergent composition is less than 15% water of the total volume, preferably less than 14%, such as less than 13%, such as less than 12%, such as less than 11%, such as less than 10%, such as less than 9%, such as less than 8%, such as less than 7%, such as less than 6%, such as less than 5%, such as less than 4%, such as less than 3%, such as less than 2% or even less than 1%.

9. A detergent composition according to any of the preceding claims, wherein the polyol is selected from the group consisting of propylene glycol or glycerol.

10. A detergent composition according to any of the preceding claims, wherein the detergent composition has turbidity less than 25 NTU, such as less than 20 NTU, such as less than 15 NTU, such as less than 10 NTU, such as less than 5 NTU or even less than 1 NTU.

11. A detergent composition according to any of the preceding claims, wherein the detergent composition in which a* and b* is between −4 and +4, when measured as described in Example 4.

12. A detergent composition according to any of the preceding claims, wherein the detergent composition further comprises at least one additional enzyme selected from the group consisting of lipases, amylases, cellulases, mannanase, pectate lyase, mannosidases or enzymes of the classes; oxidoreductase, transferase, hydrolase, lyase, isomerase, and/or ligase as well as other enzymes or mixtures thereof.

13. A method of producing a clear and/or colorless liquid detergent composition, wherein said method comprising: adding at least one enzyme and at least one anionic surfactant to a non-aqueous liquid detergent base, in an amount of at least 0.1 g anionic surfactant per g total enzyme protein in the detergent composition.

14. Use of an anionic surfactant to solubilize an enzyme, wherein the anionic surfactant is added to a non-aqueous liquid detergent base in an amount corresponding to at least 0.1 g anionic surfactant per g total enzyme protein in the detergent composition.


SEQUENCE LISTING (5 sequences)

SEQ ID NO: 1 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 269 aa, Bacillus clausii
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSSATPHVAGAAALVKQKNPSWSNVQIRNHLKNTATSLGSTNLYGSGLVNAEAATR

SEQ ID NO: 3 - protein, 270 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASEGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 4 - protein, 274 aa, Bacillus licheniformis
AQTVPYGIPLIKADKVQAQGFKGANVKVAVLDTGIQASHPDLNVVGGASFVAGEAYNTDGNGHGTHVAGTVAALDNTTGVLGVAPSVSLYAVKVLNSSGSGSYSGIVSGIEWATTNGMDVINMSLGGASGSTAMKQAVDNAYARGVVVVAAAGNSGSSGNTNTIGYPAKYDSVIAVGAVDSNSNRASFSSVGAELEVMAPGAGVYSTYPTNTYATLNGTSMASPHVAGAAALILSKHPNLSASQVRNRLSSTATYLGSSFYYGKGLINVEAAAQ

SEQ ID NO: 5 - protein, 275 aa, Bacillus amyloliquefaciens [sequence omitted]